(19) United States
(12) Patent Application Publication
(10) Pub. No.: US 2026/0032410 A1
(43) Pub. Date: Jan. 29, 2026

(54) MULTI-TENANT VEHICLE SAFETY APPLICATION

(71) Applicant: T-MOBILE INNOVATIONS LLC, Overland Park, KS (US)

(72) Inventor: Sumanth Bellam Hemanth, Bothell, WA (US)

(21) Appl. No.: 18/781,715

(22) Filed: Jul. 23, 2024

(51) Int. Cl. H04W 4/40; G08G 1/16; H04W 4/12

(52) U.S. Cl. CPC H04W 4/40; G08G 1/166; H04W 4/12

(57) ABSTRACT

A multi-tenant vehicle safety application receives first tenant data from a first wireless network tenant. The multi-tenant vehicle safety application receives second tenant data from a second wireless network tenant. The multi-tenant vehicle safety application receives first User Equipment (UE) data from a first wireless network. The multi-tenant vehicle safety application receives second UE data from a second wireless network. The multi-tenant vehicle safety application processes the first tenant data, the second tenant data, the first UE data, and the second UE data, and in response, transfers a first safety message to the first wireless network and transfers a second safety message to the second wireless network.

### TECHNICAL BACKGROUND

Wireless communication networks provide wireless data services to wireless communication devices like phones, computers, vehicles, and other user devices. The wireless data services may include internet-access, data messaging, vehicle-safety, or some other data communication product. The wireless communication networks comprise wireless access nodes like Wireless Fidelity (WIFI) hotspots, Fifth Generation New Radio (5GNR) cell towers, and satellites in earth orbit. The wireless communication networks further comprise network elements that process network signaling and handle user data like Access and Mobility Management Functions and User Plane Functions (UPFs). The wireless communication networks have edge computer systems that process user service applications at the network edge which is near to the wireless access nodes and wireless communication devices.

The vehicle safety service processes position data for the wireless communication devices to detect collisions. The position data may be exchanged between different wireless communication networks, so each wireless communication network can process the position data from the other wireless communication networks to detect vehicle collisions between their own wireless communication devices and the wireless communication devices of the other wireless communication networks.

### TECHNICAL OVERVIEW

In some examples, a method comprises the following operations. Receive first configuration data from a first wireless network tenant. Receive second configuration data from a second wireless network tenant. Receive first safety data from a first wireless network. Receive second safety data from a second wireless network. Process the first configuration data, the second configuration data, the first safety data, and the second safety data, and in response, transfer a first safety message to the first wireless network and transfer a second safety message to the second wireless network.

In some examples, a method comprises the following. A Mobile Edge Computer (MEC) executes a multi-tenant vehicle safety application that has a first tenant for a first wireless network and a second tenant for a second wireless network. The multi-tenant vehicle safety application receives first configuration data for the first tenant and receiving first safety data for the first tenant from the first wireless network. The multi-tenant vehicle safety application receives second configuration data from the second tenant and receives second safety data for the second tenant from a second wireless network. The multi-tenant vehicle safety application processes the first configuration data, the first safety data, the second configuration data, and the second safety data, and in response, transfers a first safety message to the first wireless network and transferring a second safety message to the second wireless network.

In some examples, one or more non-transitory computer readable storage media stores instructions that direct a computing system to perform operations when the instructions are executed by the computing system. The operations comprise the following. Receive first configuration data from a first wireless network tenant. Receive second configuration data from a second wireless network tenant. Receive first safety data from a first wireless network. Receive second safety data from a second wireless network. Process the first configuration data, the second configuration data, the first safety data, and the second safety data, and in response, transfer a first safety message to the first wireless network and transfer a second safety message to the second wireless network.

### DESCRIPTION OF THE DRAWINGS

FIG. 1 illustrates an exemplary data communication system to execute wireless network tenants in a multi-tenant vehicle-safety application that is shared by wireless communication networks.

FIG. 2 illustrates an exemplary operation of the data communication system to execute the wireless network tenants in the multi-tenant vehicle-safety application that is shared by the wireless communication networks.

FIG. 3 illustrates an exemplary operation of the data communication system to execute the wireless network tenants in the multi-tenant vehicle-safety application that is shared by the wireless communication networks.

FIG. 4 illustrates exemplary processing circuitry to execute wireless network tenants in a multi-tenant vehicle-safety application that is shared by wireless communication networks.

FIG. 5 illustrates an exemplary wireless communication system that executes Public Land Mobile Networks (PLMN) tenants in a multi-tenant vehicle-safety application that is shared by PLMNs.

FIG. 6 illustrates an exemplary UE in the wireless communication system that executes the PLMN tenants in the multi-tenant vehicle-safety application that is shared by the PLMNs.

FIG. 7 illustrates an exemplary Fifth Generation New Radio (5GNR) access node in the wireless communication system that executes the PLMN tenants in the multi-tenant vehicle-safety application that is shared by the PLMNs.

FIG. 8 illustrates an exemplary Network Function Virtualization Infrastructure (NFVI) in the wireless communication system that executes the PLMN tenants in the multi-tenant vehicle-safety application that is shared by the PLMNs.

FIG. 9 illustrates an exemplary Mobile Edge Computer (MEC) system in the wireless communication system that executes the PLMN tenants in the multi-tenant vehicle-safety application that is shared by the PLMNs.

FIG. 10 illustrates an exemplary multi-tenant vehicle-safety application in the wireless communication system that has the PLMN tenants and is shared by the PLMNs.

FIG. 11 illustrates an exemplary operation of the wireless communication system to execute the PLMN tenants in the multi-tenant vehicle-safety application that is shared by the PLMNs.

FIG. 12 illustrates an exemplary operation of the wireless communication system to execute the PLMN tenants in the multi-tenant vehicle-safety application that is shared by the PLMNs.

### DETAILED DESCRIPTION

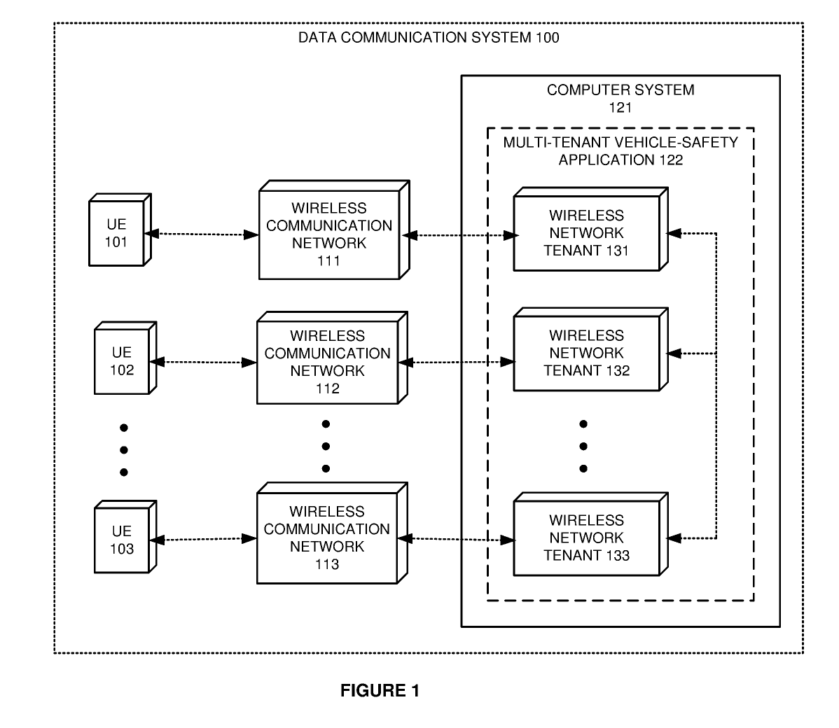

FIG. 1 illustrates exemplary data communication system 100 to execute wireless network tenants 131-133 in multi-tenant vehicle-safety application 122 that is shared by wireless communication networks 111-113. Data communication system 100 comprises User Equipment (UEs) 101-103, wireless communication networks 111-113, and computer system 121. Computer system 121 executes multi-tenant vehicle-safety application 122 that comprises wireless network tenants 131-133.

UEs 101-103 comprise wireless communication devices that are operated by users, vehicles, and/or some other mobile apparatus. UEs 101-103 may be operated by vehicle occupants, bicycle riders, pedestrians, or some other entity in proximity to a vehicle. The vehicles may be cars, trains, airplanes, aerial drones, or some other transport apparatus. Wireless communication networks 131-133 comprise wireless access nodes, network functions, and/or some other data communication equipment. Computer system 121 comprises a wireless network edge server, data center, and/or some other data processing system. Multi-tenant vehicle-safety application 122 comprises a software program that performs vehicle-safety tasks and that is shared by wireless network tenants 131-133. Wireless network tenants 131-133 comprise software components in multi-tenant vehicle-safety application 122 that serve respective wireless communication networks 131-133. Wireless network tenant 131 serves wireless communication network 111. Wireless network tenant 132 serves wireless communication network 112. Wireless network tenant 133 serves wireless communication network 113.

In some examples, computer system 121 executes multi-tenant vehicle-safety application 122. Multi-tenant vehicle-safety application 122 has wireless network tenants 111-113. Multi-tenant vehicle-safety application 122 receives tenant data from wireless network tenants 131-133. The tenant data indicates network loads, UE Identifiers (IDs), and/or some other configuration data. Multi-tenant vehicle-safety application 122 receives UE data from wireless communication networks 111-113. The UE data comprises UE IDs, UE locations, and/or some other UE information. The UE data from UEs 101-103 may traverse tenants 131-133 in some examples although that is not required. Multi-tenant vehicle-safety application 122 processes the tenant data and the UE data, and in response, transfers safety messages to wireless communication networks 111-113. Wireless communication networks 111-113 transfer the safety messages to UEs 101-103. The safety messages may indicate imminent vehicle collisions to UEs 101-103. For example, the safety messages may alert a pedestrian to an out-of-control vehicle that is heading at them from behind.

In some examples, multi-tenant vehicle-safety application 122 executes software components that are portions of wireless network tenants 131-133. The software components of tenants 131-133 generate and transfer processing results to multi-tenant vehicle-safety application 122. Multi-tenant vehicle-safety application 122 receives and processes the processing results along with the tenant data and the UE data to transfer the safety messages to wireless communication networks 111-113. For example, the software components may load UE position data and network addresses for UEs 101-103 into a shared data structure.

In some examples, multi-tenant vehicle-safety application 122 delivers individual performance levels to individual wireless network tenants 131-133 by controlling the amount of processing, memory and Input/Output (I/O) resources that are allocated to each tenant. Multi-tenant vehicle-safety application 122 isolates these individual performance levels from one another. Thus, there are enough resources to allocate, so the individual performance level that is delivered to wireless network tenant 131 is not affected by the performance levels that are delivered to wireless network tenants 132-133. The performance levels may be based on the workload for wireless network tenants 111-113 which are typically based on the load of wireless communication networks 111-113. For example, the individual performance level for wireless network tenant 131 may be based on the number of UEs that are mobile in wireless communication network 111.

In some examples, multi-tenant vehicle-safety application 122 shares a vehicle-safety data structure between wireless network tenants 131-133. Wireless network tenant 131 may have its own portions of the data structure while tenants 132-133 also have their own portions of the data structure. The data structure may be quickly scanned for data related to each of wireless communication networks 111-113 and UEs 101-103. In some examples, one or more non-transitory computer readable storage media store instructions that direct computing system 121 to perform the above-described operations when the instructions are executed by computing system 121. Thus, the instructions comprise multi-tenant vehicle safety-application 122.

UEs 101-103 and wireless communication networks 111-113 may wirelessly communicate using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and satellite data communications. UEs 101-103, wireless communication networks 111-113, and computing system 121 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data communication system 100 as described herein.

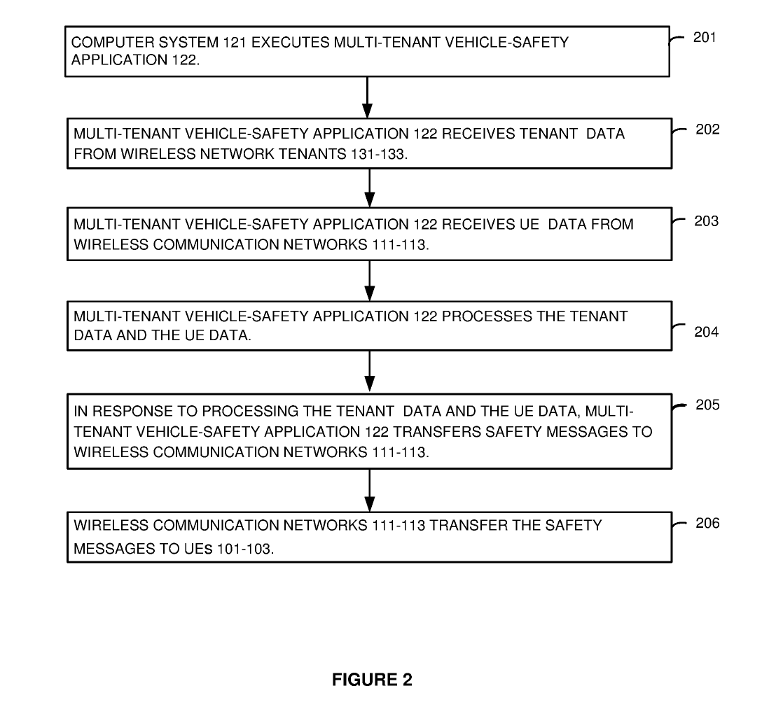

FIG. 2 illustrates an exemplary operation of data communication system 100 to execute wireless network tenants 131-133 in multi-tenant vehicle-safety application 122 that is shared by wireless communication networks 111-113. The operation may differ in other examples. Computer system 121 executes multi-tenant vehicle-safety application 122 (201). Multi-tenant vehicle-safety application 122 receives tenant data from wireless network tenants 131-133 (202). Multi-tenant vehicle-safety application 122 receives UE data from wireless communication networks 111-113 (203). Multi-tenant vehicle-safety application 122 processes the tenant data and the UE data (204). In response to this processing, multi-tenant vehicle-safety application 122 transfers safety messages wireless communication networks 111-113 (205). Wireless communication networks 111-113 transfer the safety messages to UEs 101-103 (206).

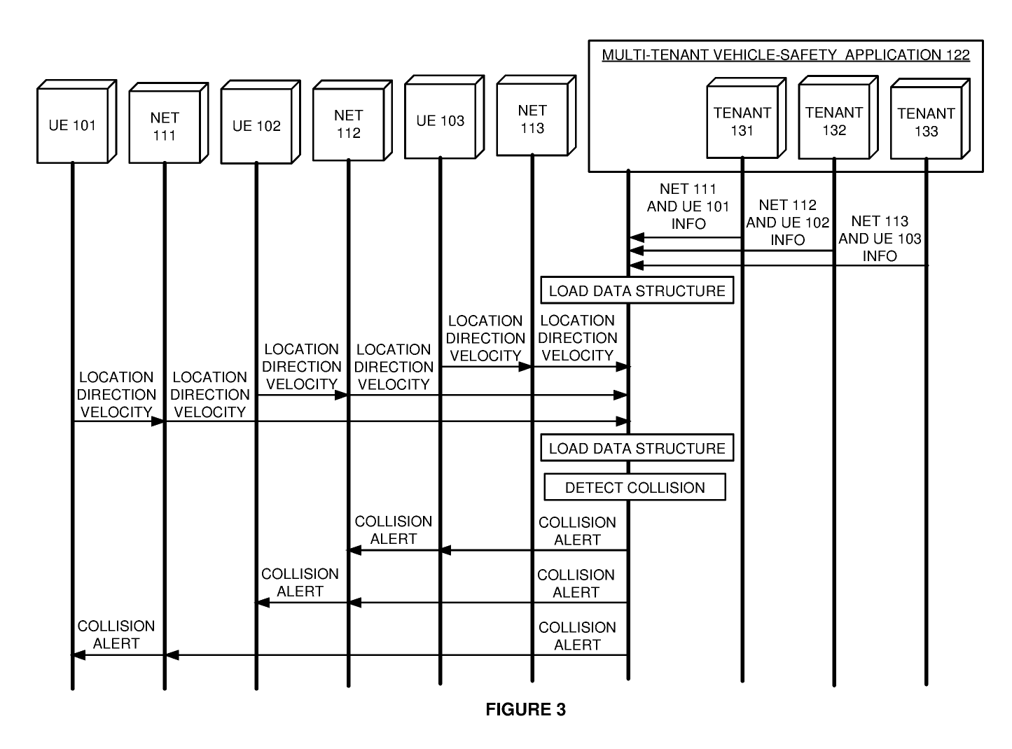

FIG. 3 illustrates an exemplary operation of data communication system 100 to execute wireless network tenants 131-133 in multi-tenant vehicle-safety application 122 that is shared by wireless communication networks 111-113. The operation may differ in other examples. Multi-tenant vehicle-safety application 122 receives tenant information for wireless communication network 111 and UE 101 from wireless network tenant 131. Multi-tenant vehicle-safety application 122 receives tenant information for wireless communication network 112 and UE 102 from wireless network tenant 132. Multi-tenant vehicle-safety application 122 receives tenant information for wireless communication network 113 and UE 103 from wireless network tenant 133. Multi-tenant vehicle-safety application 122 loads the tenant data and the UE data into a shared data structure.

Wireless communication network 113 receives location, direction, and velocity data from UE 103. Wireless communication network 113 transfers the location, direction, and velocity data for UE 103 to multi-tenant vehicle-safety application 122. Wireless communication network 112 receives location, direction, and velocity data from UE 102. Wireless communication network 112 transfers the location, direction, and velocity data for UE 102 to multi-tenant vehicle-safety application 122. Wireless communication network 111 receives location, direction, and velocity data from UE 101. Wireless communication network 111 transfers the location, direction, and velocity data for UE 101 to multi-tenant vehicle-safety application 122. Multi-tenant vehicle-safety application 122 loads this location, direction, and velocity data for UEs 101-103 into a shared data structure. This transfer and storage of location, direction, and velocity data for UEs 101-103 is on-going and may traverse tenants 131-133 in some examples. Multi-tenant vehicle-safety application 122 retrieves this UE position information from the shared data structure. Multi-tenant vehicle-safety application 122 processes this UE position information, and in response, transfers collision alerts for UEs 101-103 to wireless communication networks 111-113. Wireless communication networks 111-113 transfer the collision alerts to UEs 101-103.

Advantageously, data communication system 100 efficiently and effectively delivers safety messages to UEs 101-103 over wireless communication networks 111-113. The use of multi-tenant vehicle-safety application 122 may improve the delivery speed of these safety messages when multiple wireless communication networks are involved.

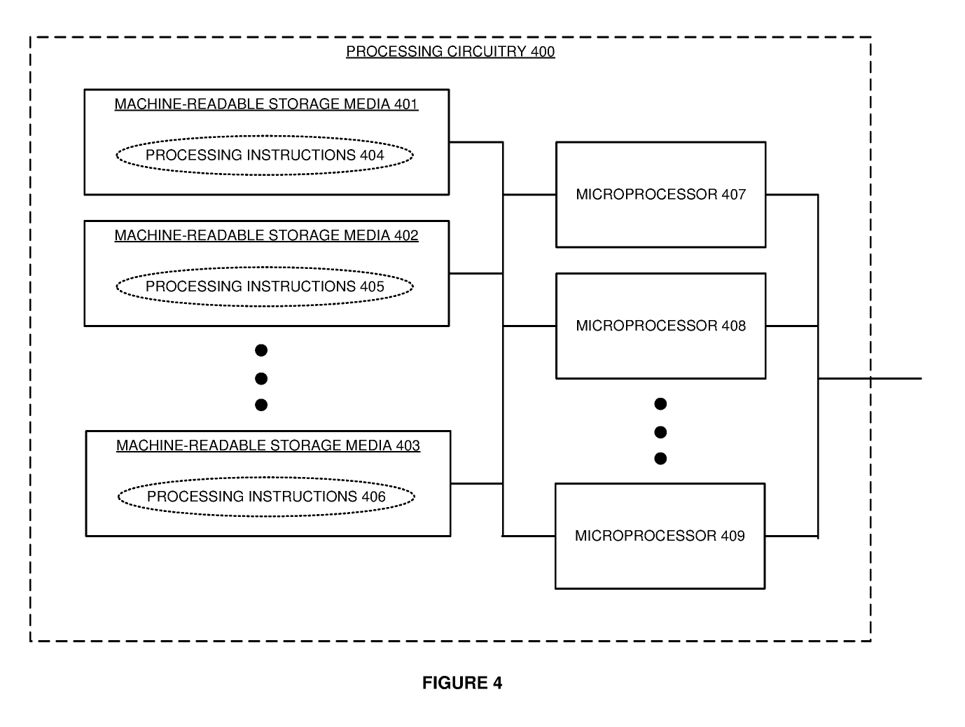

FIG. 4 illustrates exemplary processing circuitry to execute wireless network tenants in a multi-tenant vehicle-safety application that is shared by wireless communication networks. Processing circuitry 400 comprises an example of the wireless communication devices for entities 101-103, wireless communication networks, and computing system 121, although the devices for entities 101-103, networks 111-113, and system 121 may differ. Processing circuitry 400 comprises machine-readable storage media 401-403 and microprocessors 407-409 that are communicatively coupled. Machine-readable storage media 401-403 store processing instructions 404-406 in a non-transitory manner. Microprocessors 407-409 comprise DSPs, CPUs, GPUs, ASICs, and/or some other data processing hardware. Machine-readable storage media 401-403 comprises RAM, flash circuitry, disk drives, and/or some other type of data storage apparatus. Microprocessors 407-409 retrieve processing instructions 404-406 from non-transitory machine-readable storage media 401-403. Microprocessors 407-409 execute processing instructions 404-406 to execute wireless network tenants in a multi-tenant vehicle-safety application that is shared by wireless communication networks as described above for data communication system 100 and as described below for wireless communication system 500. The amount of storage media, microprocessors, processing instructions that are shown in FIG. 4 may vary in other examples.

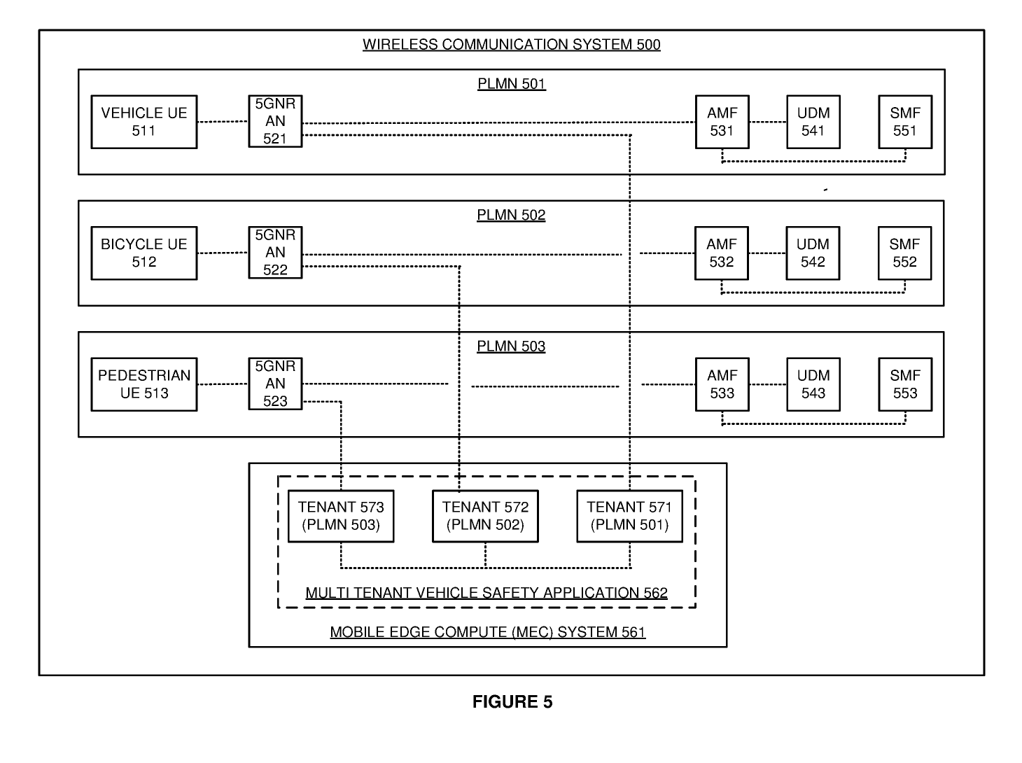

FIG. 5 illustrates exemplary wireless communication system 500 that executes Public Land Mobile Networks (PLMN) tenants 571-573 in multi-tenant vehicle-safety application 562 that is shared by PLMNs 501-503. Wireless communication system 500 comprises an example of data communication system 100 and processing circuitry 400, although system 100 and circuitry 400 may differ. Wireless communication system 500 comprises PLMNs 501-503 and Mobile Edge Compute (MEC) system 561. PLMN 501 comprises vehicle User Equipment (UE) 511, Fifth Generation New Radio (5GNR) Access Node (AN) 521, Access and Mobility Management Function (AMF) 531, Unified Data Management (UDM) 541, and Session Management Function (SMF) 551. PLMN 502 comprises bicycle UE 512, 5GNR AN 522, AMF 532, UDM 542, and SMF 552. PLMN 503 comprises pedestrian UE 513, 5GNR AN 523, AMF 533, UDM 543, and SMF 553.

MEC system 561 comprises multi-tenant vehicle safety application 562. Multi-tenant vehicle safety application 562 comprises tenants 571-573 for respective PLMNs 501-503. MEC system 561 executes multi-tenant vehicle safety application 562 to serve a vehicle safety service to UEs 511-513 and other UEs in PLMNs 501-503. MEC system 561 is typically co-located or extremely near 5GNR ANs 521-523. For example, MEC system 561 may share a data center with the Centralized Units (CUs) for 5GNR ANs 521-523.

In PLMN 501, vehicle UE 511 attaches to 5GNR AN 521 and registers with AMF 531. AMF 531 retrieves subscriber information for vehicle UE 511 from UDM 541. AMF 531 and SMF 551 interact responsive to the subscriber information to develop UE context for the vehicle-safety service. The UE context includes network addresses and quality-of-service for a data link between vehicle UE 511 and multi-tenant vehicle safety application 562. AMF 521 transfers the UE context to 5GNR AN 521 and vehicle UE 511. In response to the UE context, Vehicle UE 511 registers with tenant 571 and starts transferring vehicle location, direction, and velocity data to tenant 571. Tenant 571 stores the information in a shared data structure in multi-tenant vehicle safety application 562.

In PLMN 502, bicycle UE 512 attaches to 5GNR AN 522 and registers with AMF 532. AMF 532 retrieves subscriber information for bicycle UE 512 from UDM 542. AMF 532 and SMF 552 interact responsive to the subscriber information to develop UE context for the vehicle-safety service. The UE context includes network addresses and quality-of-service for a data link between bicycle UE 512 and multi-tenant vehicle safety application 562. AMF 521 transfers the UE context to 5GNR AN 522 and bicycle UE 512. In response to the UE context, bicycle UE 512 registers with tenant 572 and starts transferring bicycle location, direction, and velocity data to tenant 572. Tenant 572 stores the information in the shared data structure in multi-tenant vehicle safety application 562.

In PLMN 503, pedestrian UE 513 attaches to 5GNR AN 523 and registers with AMF 533. AMF 533 retrieves subscriber information for pedestrian UE 513 from UDM 543. AMF 533 and SMF 553 interact responsive to the subscriber information to develop UE context for the vehicle-safety service. The UE context includes network addresses and quality-of-service for a data link between pedestrian UE 513 and multi-tenant vehicle safety application 562. AMF 523 transfers the UE context to 5GNR AN 523 and pedestrian UE 513. In response to the UE context, pedestrian UE 513 registers with tenant 573 and starts transferring pedestrian location, direction, and velocity data to tenant 573. Tenant 573 stores the information in the shared data structure in multi-tenant vehicle safety application 562.

Multi-tenant vehicle safety application 562 processes tenant data from tenants 571-573 to identify UEs 511-513 and their respective PLMNs 501-503. Multi-tenant vehicle safety application 562 processes the UE position information in the shared data structure to determine when UEs 511-513 are proximate to one another. UE proximity may comprise less than 100 feet or some other distance measure. UEs 511-513 continuously provide new location, velocity, and direction information to tenants 571-573 which store the UE position data in the shared data structure. Based on the UE position information in the shared data structure, multi-tenant vehicle safety application 562 determines that vehicle UE 511 will collide with bicycle UE 512 and pedestrian UE 513. In response, multi-tenant vehicle safety application 562 transfers collision alerts to UEs 511-513 over 5GNR ANs 521-523.

Multi-tenant vehicle-safety application 562 determines the individual workloads for tenants 571-573 based on the number and activity of their UEs as indicated by PLMNs 501-503. Multi-tenant vehicle-safety application 563 delivers individual performance levels to tenants 571-573 based on their workloads. PLMNs with more UEs that generate more UE data receive higher performance levels than PLMNs with fewer UEs that generate less UE data. The performance levels comprise processing time, memory amount, and input/output bandwidth. Multi-tenant vehicle-safety application 562 isolates these individual performance levels from one another. Thus, the individual performance level that is delivered to PLMN tenant 571 is not affected by the other performance levels that are delivered to PLMN tenants 572-573.

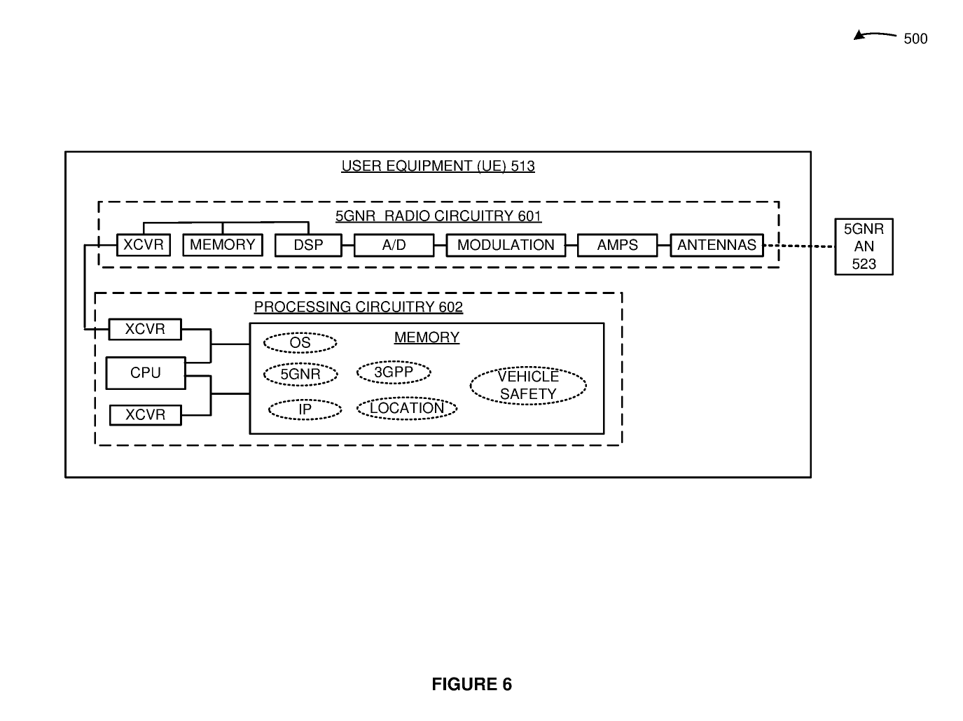

FIG. 6 illustrates exemplary UE 513 in wireless communication system 500 that executes PLMN tenants 571-573 in multi-tenant vehicle-safety application 562 that is shared by PLMNs 501-503. UE 513 comprises an example of UEs 101-103, processing circuitry 400, and UEs 511-512 although UEs 101-103,circuitry 400, and UEs 511-512 may differ. UE 513 comprises Fifth Generation New Radio (5GNR) radio circuitry 601 and processing circuitry 602. Radio circuitry 601 comprises antennas, amplifiers, filters, modulation, analog-to-digital interfaces, DSPs, memories, and transceivers (XCVRs) that are coupled over bus circuitry. Processing circuitry 602 comprises one or more CPUs, one or more memories, and one or more transceivers that are coupled over bus circuitry. The one or more memories in processing circuitry 602 store software like an Operating System (OS), 5GNR Application (5GNR), 3GPP Application (3GPP), Internet Protocol application (IP), location application (LOCATION), and Vehicle Safety application (VEHICLE SAFETY). The antennas in radio circuitry 601 exchange wireless signals with 5GNR AN 523. Transceivers in radio circuitry 601 are coupled to transceivers in processing circuitry 602. In processing circuitry 602, the one or more CPUs retrieve the software from the one or more memories and execute the software to direct the operation of UE 513 as described herein. In particular, the location application determines UE position data, and the vehicle safety application transfers the UE position data to multi-tenant vehicle-safety application 562. UE 513 also presents safety messages from multi-tenant vehicle-safety application 562 to its user.

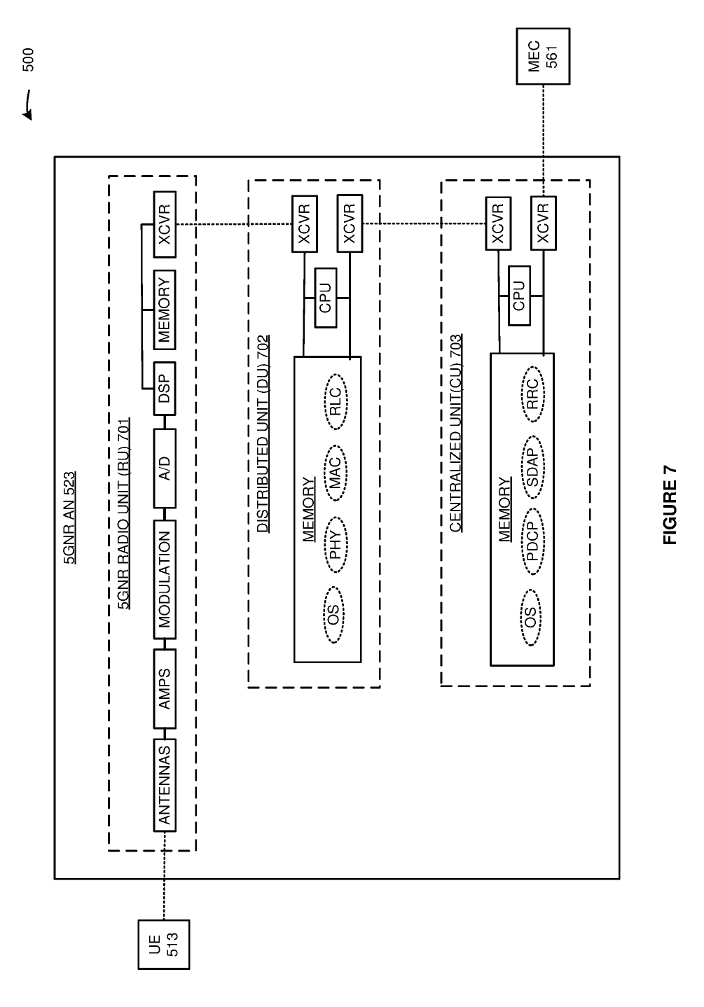

FIG. 7 illustrates an exemplary Fifth Generation New Radio (5GNR) Access Node (AN) in wireless communication system 500 that executes vehicle-safety tenants 571-573 in multi-tenant vehicle-safety application 562 that is shared by PLMNs 501-503. 5GNR AN 523 comprises an example of wireless communication networks 111-113, processing circuitry 400, and 5GNR ANs 521-522, although networks 111-113, circuitry 400, and ANs 521-522 may differ. 5GNR AN 523 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. DU 702 comprises memory, CPU, user interfaces and components, and transceivers that are coupled over bus circuitry. The memory in DU 702 stores operating system and 5GNR network applications for Physical Layer (PHY), Media Access Control (MAC), and Radio Link Control (RLC). CU 703 comprises memory, CPU, and transceivers that are coupled over bus circuitry. The memory in CU 703 stores an operating system and5GNR network applications for Packet Data Convergence Protocol (PDCP), Service Data Adaption Protocol (SDAP), and Radio Resource Control (RRC). The antennas in 5GNR RU 701 are wirelessly coupled to UE 513 over 5GNR links. Transceivers in 5GNR RU 701 are coupled to transceivers in DU 702. Transceivers in DU 702 are coupled to transceivers in CU 703. Transceivers in CU 703 are coupled to transceivers in MEC 561. The DSP and CPU in RU 701, DU 702, and CU 703 execute the radio applications, operating systems, and network applications to exchange data and signaling between UE 513 and MEC 561 as described herein. In some examples, CU 703, MEC 561, and possibly the CUs for ANs 521-522 are co-located and/or share a common data center.

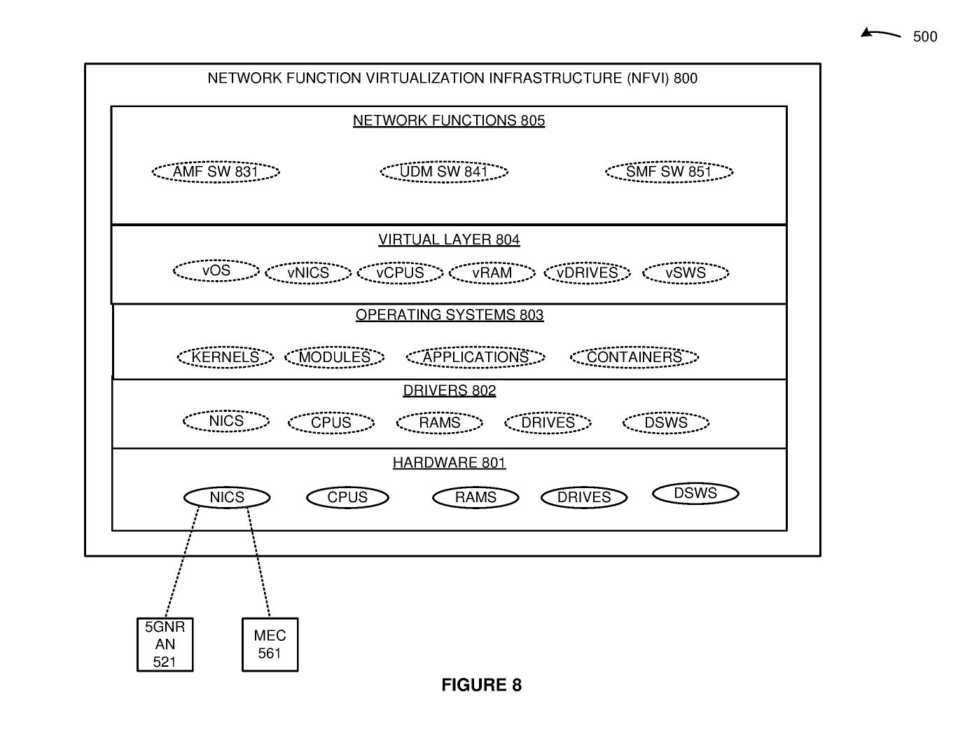

FIG. 8 illustrates an exemplary Network Function Virtualization Infrastructure (NFVI) 800 in wireless communication system 500 that executes vehicle-safety tenants 571-573 in multi-tenant vehicle-safety application 562 that is shared by PLMNs 501-503. NFVI 800 is a part of PLMN 501, and PLMNs 502-503 could be configured with NFVIs in a similar manner. NFVI 800 comprises an example of wireless communication networks 111-113 and processing circuitry 400, although networks 111-113 and circuitry 400 may differ. NFVI 800 comprises hardware 801, hardware drivers 802, operating systems 803, virtual layer 804, and network functions 805. Hardware 801 comprises Network Interface Cards (NICS), CPUS, RAM, Flash/Disk Drives (DRIVES), and Data Switches (DSWS). Hardware drivers 802 comprise software that is resident in the NICS, CPUS, RAM, DRIVES, and DSWS. Operating systems 803 comprise kernels, modules, applications, and containers. Virtual layer 804 comprises virtual Operating Systems (vOS), vNICS, vCPUS, vRAM, vDRIVES, and vSWS. Network Functions 805 comprises AMF Software (SW) 831, UDM SW 841, and SMF SW 851. The NICS in hardware 801 are coupled to 5GNR AN 521 and MEC 561. Hardware 801 executes hardware drivers 802, operating systems 803, virtual layer 804, and network functions 805 to form and operate AMF 531, UDM 541, and SMF 551 as described herein. NFVI 800 comprises one or more microprocessors and one or more non-transitory machine-readable storage media that store processing instructions that direct NFVI 800 to exchange data and signaling with 5GNR AN 521 and MEC 561 as described herein.

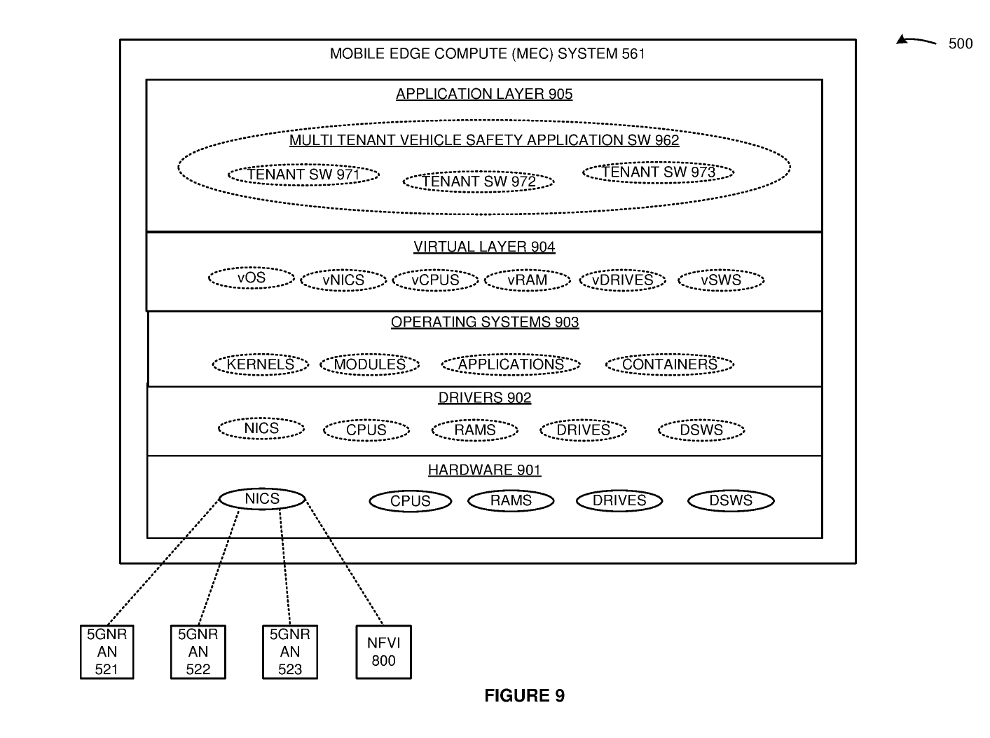

FIG. 9 illustrates exemplary Mobile Edge Computer (MEC) system 561 in wireless communication system 500 that executes PLMN tenants 571-573 in multi-tenant vehicle-safety application 562 that is shared by PLMNs 501-503. MEC system 561 comprises an example of computer system 121 and processing circuitry 400, although system 121 and circuitry 400 may differ. MEC system 561 comprises hardware 901, hardware drivers 902, operating systems 903, virtual layer 904, and application layer 905. Hardware 901 comprises Network Interface Cards (NICS), CPUS, RAM, Flash/Disk Drives (DRIVES), and Data Switches (DSWS). Hardware drivers 902 comprise software that is resident in the NICS, CPUS, RAM, DRIVES, and DSWS. Operating systems 903 comprise kernels, modules, applications, and containers. Virtual layer 904 comprises virtual Operating Systems (vOS), vNICS, vCPUS, vRAM, vDRIVES, and vSWS. Application Layer 905 comprises multi-tenant vehicle safety application Software (SW) 962. TENANT SW 971, TENANT SW 972, and TENANT SW 973. The NICS in hardware 901 are coupled to 5GNR ANs 521-523 and NFVI 800. Hardware 901 executes hardware drivers 902, operating systems 903, virtual layer 904, and application layer 905 to form and operate multi-tenant vehicle application 561 having PLMN tenants 571-573. MEC system 561 comprises one or more microprocessors and one or more non-transitory machine-readable storage media that store processing instructions that direct MEC system 561 to exchange data and signaling with 5GNR ANs 521-523 and NFVI 800 as described herein.

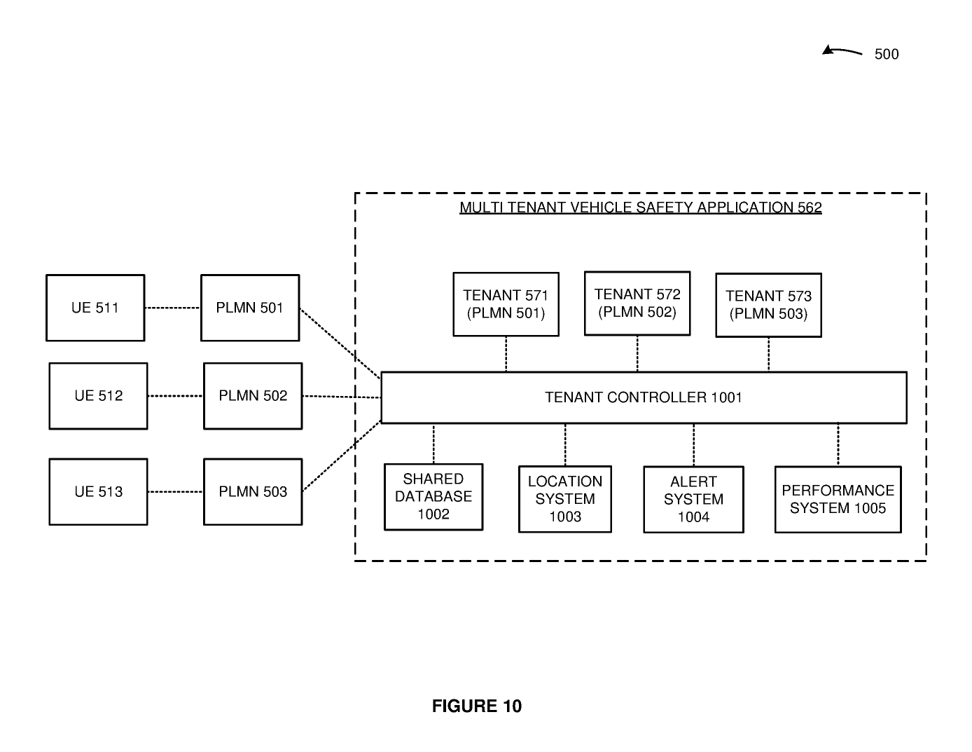

FIG. 10 illustrates exemplary multi-tenant vehicle-safety application 562 in wireless communication system 500 that has PLMN tenants 571-573 and that is shared by PLMNs 501-503. Multi-tenant vehicle-safety application 562 comprises an example of multi-tenant vehicle-safety application 121 and processing circuitry 400, although application 121 and circuitry 400 may differ. Multi-tenant vehicle-safety application 562 comprises tenant controller 1001, shared database 1002, location system 1003, alert system 1004, performance system 1005, and tenants 571-573 for respective PLMNs 501-503. Tenant controller 1001 performs basic vehicle safety tasks based on tenant data from tenants 571-573 and UE position data from UEs 511-513. Shared database 1002 stores data for tenants 571-573 in a common data structure. Location system 1003 processes the UE position data for UEs 501-503 to identify proximate UEs. Alert system 1004 processes the UE position data for the proximate UEs to detect imminent vehicle collisions among the UEs and send corresponding alerts. Performance system 1005 controls the quality of the computer performance delivered to tenants 571-573 based on the loads of respective PLMNs 501-503. For example, performance system 1005 may individually control the amount of CPU, memory, and I/O resources that are allocated to each of tenants 571-573 by MEC system 561.

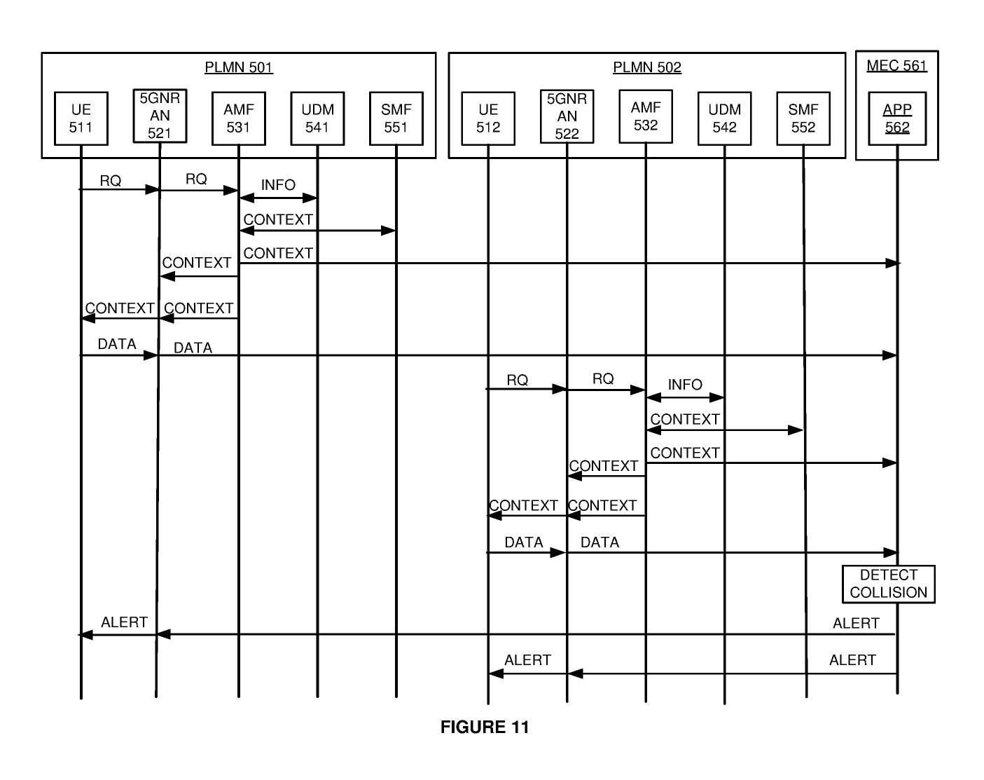

FIG. 11 illustrates an exemplary operation of wireless communication system 500 to execute PLMN tenants 571-573 in multi-tenant vehicle-safety application 562 that is shared by PLMNs 501-503. The operation may vary in other examples. UE 511 requests a vehicle-slice from AMF 531 over 5GNR AN 521. AMF 531 retrieves subscriber information for UE 511 from UDM 541, AMF 531 and SMF 551 interact to develop UE context for the vehicle-safety slice like network addresses and quality-of-service levels. AMF 531 transfer some of the UE context to vehicle safety application (APP) 562. AMF 531 transfer some of the UE context to 5GNR AN 521. AMF 531 transfer some of the UE context to UE 511 over 5GNR AN 521. In response to the UE context, UE 511 transfers UE position data like location, direction, and velocity to vehicle safety application 562.

UE 512 requests a vehicle-safety slice from AMF 532 over 5GNR AN 522. AMF 532 retrieves subscriber information for UE 512 from UDM 542. AMF 532 and SMF 552 interact to develop UE context for the vehicle-safety slice like network addresses and quality-of-service levels. AMF 532 transfer some of the UE context to vehicle safety application 562. AMF 532 transfer some of the UE context to 5GNR AN 522. AMF 532 transfer some of the UE context to UE 512 over 5GNR AN 522. In response to the UE context, UE 512 transfers UE position data like location, direction, and velocity to multi-tenant vehicle-safety application 562.

Multi-tenant vehicle-safety application 562 processes the UE position data from UEs 511-512 along with configuration data for tenants 531-532 to detect a collision between UEs 511-512. In response to the collision detection, multi-tenant vehicle-safety application 562 transfers collision alerts to UE 511 over 5GNR AN 521 and to UE 512 over 5GNR AN 522.

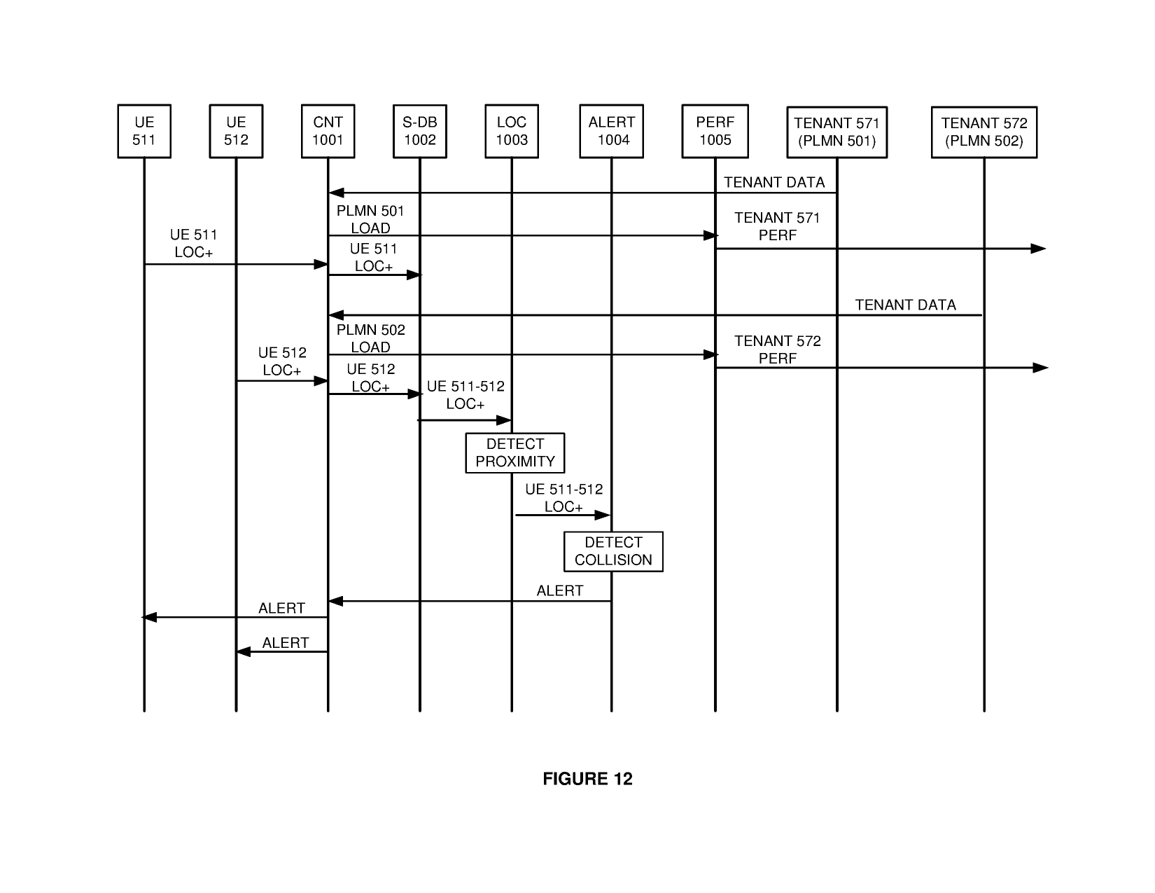

FIG. 12 illustrates an exemplary operation of wireless communication system 500 to execute PLMN tenants 571-573 in multi-tenant vehicle-safety application 562 that is shared by PLMNs 501-503. The operation may vary in other examples. Tenant 571 transfers tenant data for PLMN 501 to tenant controller (CNT) 1001. The tenant data indicates loading for PLMN 501 the was determined by historical usage or received from PLMN 501. Tenant controller 1001 transfers the load for PLMN 501 to performance system (PERF) 1005. Based on the load of PLMN 501, performance system transfers a performance level for tenant 571 to the virtual layer for implementation by MEC system 561. The performance level may comprise CPU time, memory amount, I/O speed, and the like. The performance level for tenant 571 is isolated from the performance levels for other tenants. Tenant controller 1001 receives the location, direction, and velocity data for UE 511 and stores the location, direction, and velocity data for UE 511 in shared database (S-DB) 1002. In an alternative operation, tenant 571 receives the location, direction, and velocity data for UE 511 and stores the location, direction, and velocity data for UE 511 in shared database 1002.

Contemporaneously, tenant 572 transfers tenant data for PLMN 502 to tenant controller 1001. The tenant data indicates loading for PLMN 502 the was determined by historical usage or received from PLMN 502. Tenant controller 1001 transfers the load for PLMN 502 to performance system 1005. Based on the load of PLMN 502 performance system 1005 transfers a performance level for tenant 572 to the virtual layer for implementation. The performance level may comprise CPU time, memory amount, I/O speed, and the like. The performance level for tenant 571 is isolated from the performance levels for other tenants. Tenant controller 1001 receives location, direction, and velocity data for UE 512 and stores the location, direction, and velocity data for UE 512 in shared database 1002. In an alternative operation, tenant 572 receives the location, direction, and velocity data for UE 512 and stores the location, direction, and velocity data for UE 511 in shared database 1002.

Location system 1003 retrieves and processes the location, direction, and velocity data for UEs 511-512 (and typically other UEs) to detect proximate UEs. Based on detected proximity, location system transfers location, direction, and velocity data for UEs 511-512 to alert system 1004. Alternatively, alert system 1004 may read this UE position data from shared database 1002 after a proximity notification for UEs 511-512 from location system 1003. Alert system 1004 processes the location, direction, and velocity data for UEs 511-512 to detect an imminent collision, and in response, transfers collision alerts to UEs 511-512 over controller 1001.

Advantageously, wireless communication system 500 efficiently and effectively delivers safety messages to UEs 511-513 over PLMNs 501-503. The use of multi-tenant vehicle-safety application 562 may improve the delivery speed of these safety messages when multiple PLMNs are involved.

The wireless communication system circuitry described above comprises computer hardware and software that form special-purpose data communication circuitry to execute tenants in a multi-tenant vehicle-safety application. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry system to execute the tenants in the multi-tenant vehicle-safety application.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
executing a multi-tenant vehicle-safety application that has a first wireless network tenant and a second wireless network tenant;
receiving first tenant data from the first wireless network tenant;
receiving second tenant data from the second wireless network tenant;
receiving first User Equipment (UE) data from the first wireless network;
receiving second UE data from a second wireless network; and
processing the first tenant data, the second tenant data, the first UE data, and the second UE data, and in response, transferring a first safety message to the first wireless network and transferring a second safety message to the second wireless network.

2. The method of claim 1, further comprising:
executing first software that comprises a portion of the first wireless network tenant, and in response, generating first processing results;
executing second software that comprises a portion of the second wireless network tenant, and in response, generating second processing results; and wherein
processing the first tenant data, the second tenant data, the first UE data, and the second UE data, and in response, transferring the first safety message to the first wireless network and transferring the second safety message to the second wireless network comprises processing the first tenant data, the second tenant data, the first UE data, the second UE data, the first processing results, and the second processing results, and in response, transferring the first safety message to the first wireless network and transferring the second safety message to the second wireless network.

3. The method of claim 1, wherein executing the multi-tenant vehicle-safety application comprises:
isolating a first performance level for the first wireless network tenant from a second performance level for the second wireless network tenant; and
isolating the second performance level for the second wireless network tenant from the first performance level for the first wireless network tenant.

4. The method of claim 1, wherein executing the multi-tenant vehicle-safety application comprises:
delivering a first performance level to the first wireless network tenant based on a first workload for the first wireless network tenant; and
delivering a second performance level to the second wireless network tenant based on a second workload for the second wireless network tenant.

5. The method of claim 1, further comprising sharing a vehicle-safety data structure between the first wireless network tenant and the second wireless network tenant.

6. The method of claim 1, wherein transferring the first safety message to the first wireless network and transferring a second safety message to the second wireless network comprises transferring a first vehicle-collision alert to the first wireless network and transferring a second vehicle-collision alert to the second wireless network.

7. The method of claim 1, wherein:
the first wireless network receives the first data from a wireless UE operated by a pedestrian; and
the first wireless network transfers the first safety message to the wireless UE operated by the pedestrian.

8. The method of claim 1, wherein:
the first wireless network receives the first data from a UE operated by a bicycler; and
the first wireless network transfers the first safety message to the UE operated by the bicycler.

9. The method of claim 1, wherein:
the first wireless network receives the first data from a UE operated in a vehicle; and
the first wireless network transfers the first safety message to the UE operated in the vehicle.

10. A method comprising:
a Mobile Edge Computer (MEC) executing a multi-tenant vehicle safety application that has a first network tenant for a first wireless network and a second network tenant for a second wireless network;
the multi-tenant vehicle safety application receiving first tenant data from the first network tenant and receiving first User Equipment (UE) position data from the first wireless network;
the multi-tenant vehicle safety application receiving second data tenant from the second network tenant and receiving second UE position data from a second wireless network; and
the multi-tenant vehicle safety application processing the first tenant data, the first UE position data, the second tenant data, and the second UE position data, and in response, transferring a first safety message to the first wireless network and transferring a second safety message to the second wireless network.

11. The method of claim 10, wherein the multi-tenant vehicle safety application transferring the first safety message to the first wireless network and transferring a second safety message to the second wireless network comprises transferring a first vehicle-collision alert to the first wireless network and transferring a second vehicle-collision alert to the second wireless network.

12. One or more non-transitory computer readable storage media that stores instructions that direct a computing system to perform operations when the instructions are executed by the computing system, the operations comprising:
executing a multi-tenant vehicle-safety application that has a first wireless network tenant and a second wireless network tenant;
receiving first tenant data from the first wireless network tenant;
receiving second tenant data from the second wireless network tenant;
receiving first User Equipment (UE) data from the first wireless network;
receiving second UE data from a second wireless network; and
processing the first tenant data, the second tenant data, the first UE data, and the second UE data, and in response, transferring a first safety message to the first wireless network and transferring a second safety message to the second wireless network.

13. The one or more non-transitory computer readable storage media of claim 12, further comprising:
executing first software that comprises a portion of the first wireless network tenant, and in response, generating first processing results;
executing second software that comprises a portion of the second wireless network tenant, and in response, generating second processing results; and wherein
processing the first tenant data, the second tenant data, the first UE data, and the second UE data, and in response, transferring the first safety message to the first wireless network and transferring the second safety message to the second wireless network comprises processing the first tenant data, the second tenant data, the first UE data, the second UE data, the first processing results, and the second processing results, and in response, transferring the first safety message to the first wireless network and transferring the second safety message to the second wireless network.

14. The one or more non-transitory computer readable storage media of claim 12, further comprising:
isolating a first performance level for the first wireless network tenant from a second performance level for the second wireless network tenant; and
isolating the second performance level for the second wireless network tenant from the first performance level for the first wireless network tenant.

15. The one or more non-transitory computer readable storage media of claim 12, further comprising:
delivering a first performance level to the first wireless network tenant based on a first workload for the first wireless network tenant; and
delivering a second performance level to the second wireless network tenant based on a second workload for the second wireless network tenant.

16. The one or more non-transitory computer readable storage media of claim 12, further comprising sharing a vehicle-safety data structure between the first wireless network tenant and the second wireless network tenant.

17. The one or more non-transitory computer readable storage media of claim 12, wherein transferring the first safety message to the first wireless network and transferring a second safety message to the second wireless network comprises transferring a first vehicle-collision alert to the first wireless network and transferring a second vehicle-collision alert to the second wireless network.

18. The one or more non-transitory computer readable storage media of claim 12, further comprising:
the first wireless network receives the first data from a wireless UE operated by a pedestrian; and
the first wireless network transfers the first safety message to the wireless UE operated by the pedestrian.

19. The one or more non-transitory computer readable storage media of claim 12, further comprising:
the first wireless network receives the first data from a UE operated by a bicycler; and
the first wireless network transfers the first safety message to the UE operated by the bicycler.

20. The one or more non-transitory computer readable storage media of claim 12, further comprising:
the first wireless network receives the first data from a UE operated in a vehicle; and
the first wireless network transfers the first safety message to the UE operated in the vehicle.
